(19) United States
(12) Patent Application Publication
(10) Pub. No.: US 2025/0026060 A1
(43) Pub. Date: Jan. 23, 2025

(54) CONTAINER TREATMENT SYSTEM AND METHOD FOR PRODUCING AND TREATING A PREFORM

(71) Applicant: Krones AG, Neutraubling (DE)

(72) Inventors: Florian GELTINGER, Donaustauf (DE); Dieter WUENSCHE, Straubing (DE); Robert AUST, Barbing (DE); Jochen FORSTHOEVEL, Regensburg (DE)

(21) Appl. No.: 18/777,238

(22) Filed: Jul. 18, 2024

(30) Foreign Application Priority Data
Jul. 19, 2023 (DE) 10 2023 119 036.9

(51) Int. Cl. B29C 45/84; B29C 45/76; B29C 45/78; B29C 49/06; B29K 23/00; B29K 67/00; B29L 31/00

(52) U.S. Cl. CPC B29C 45/84; B29C 45/7646; B29C 45/78; B29C 49/06; B29C 2945/7604; B29C 2945/7605; B29C 2945/76163; B29C 2945/76531; B29C 2945/76551; B29C 2945/76625; B29C 2945/76769; B29K 2023/06; B29K 2023/12; B29K 2067/003; B29L 2031/712

(57) ABSTRACT

A container treatment system comprising a production machine for producing a preform, in particular an injection molding machine, at least one container treatment machine arranged downstream of the production machine in a transport direction of the preform, and a control unit, wherein the production machine and the at least one container treatment machine are integral with one another, wherein the control unit is designed to synchronize a first operation of the production machine and a second operation of the at least one container treatment machine with one another.

### CROSS REFERENCE TO RELATED APPLICATION

The present application claims priority to German Patent Application No. 10 2023 119 036.9 filed on Jul. 19, 2023. The entire contents of the above-listed application are hereby incorporated by reference for all purposes.

### TECHNICAL FIELD

The present disclosure relates to a container treatment system for producing and treating a preform and a corresponding method.

### BACKGROUND

Container cleaning systems are well known from the prior art. For the production of containers, container treatment systems typically include a blow molding machine, which can be used to form preforms into containers. Injection molding methods have become established for the production of preforms.

### SUMMARY

Until now, the production of the preforms using the injection molding method and the forming of the preforms into containers using the blow molding method have been carried out separately in terms of time and location. For this reason, container treatment machines from the prior art typically include a storage unit in which the preforms that have already been produced are stored as bulk material and can be made available to the blow molding machine as required. The preforms stored in the storage unit are first fed to a sorting device, where they are separated so that they can then be fed to the blow molding machine in an ordered form. The preforms can then be formed into containers by the blow molding machine. In downstream processes, further treatment steps can be carried out on the containers in the container treatment system, such as coating, labeling, printing, filling, and/or closing the containers.

However, the separate, in terms of time and location, production and further processing of the preforms into containers and the associated transportation of the preforms to the container treatment machine and storage of the preforms as bulk material entail a number of disadvantages. Storage and transportation can damage the preforms and cause additional costs. Unwanted contamination of the preforms due to long storage times or the transport also cannot be ruled out.

### Object

Based on the prior art, the task to be solved is to make the operation of a container treatment system more efficient and at the same time increase the quality of the containers produced.

### Achievement

This object is achieved according to the disclosure by the container treatment system as described herein.

The container treatment system according to the disclosure comprises a production machine, in particular an injection molding machine, for producing a preform, at least one container treatment machine arranged downstream of the production machine in a transport direction of the preform, and a control unit, wherein the production machine and the at least one container treatment machine are integral with one another and the control unit is designed to synchronize a first operation of the production machine and a second operation of the at least one container treatment machine with one another.

The production machine can be in particular an injection molding machine. Alternatively, it can also be a device for producing preforms by means of a compression molding method or a device for producing preforms by means of an injection compression molding method. However, it can also be any other device suitable for producing a preform.

The container treatment machine can be any type of container treatment machine that is suitable for producing a container from a preform and/or for treating a container produced from the preform. For example, the container treatment machine can be a blow molding machine, which can be designed as a stretch blow molding machine or an extrusion blow molding machine, and/or a heating device, which can be designed as an infrared heating device or microwave heating device, for example. A thermal buffer section can optionally be provided between the production machine and the heating device. However, the container treatment machine can also be a container treatment machine designed to pre-treat a container, for example by means of a flame pyrolysis plasma or corona method, a labeling machine, a direct printing device, a filler, and/or a capper. In particular, a plurality of container treatment machines can also be arranged in series downstream of the production machine in the transport direction of the preform. Any possible combination of the above-named and any other container treatment machine can be provided.

The container treatment machine can be used to produce and treat a wide variety of containers from the preforms, wherein the containers are optionally bottles used in the beverage industry. However, any other type of container can also be produced from the preforms, such as cans, jars, cups or tubes, as used in the beverage, pharmaceutical, healthcare or food industries, for example, or any other container which can be suitable for holding any liquid or pasty medium.

An integral structure of the production machine and the at least one container treatment machine means that the production machine and the at least one container treatment machine form a unit. This means that the preforms can be produced in the same system in which they are further processed into containers. Optionally, for example, it can be provided that the production machine and the container treatment machine are connected to each other by means of a transport device, such as a conveyor belt or a rotating star, so that the preforms produced by the production machine can be transported directly and in an ordered manner to the at least one container treatment machine. The transport device can be designed to be sterile, so that contamination of the containers during transportation from the production machine to the at least one container treatment machine can be avoided.

In particular, the first operation can be a number of preforms that can be produced per time interval, for example per hour, by means of the production machine, or a number of preforms that can be delivered per time interval, for example per hour, to the container treatment machine arranged downstream in the transport direction. The number of preforms that can be produced by the production machine per time interval and the number of preforms that can be discharged per time interval can be different, for example, if the production machine performs an optional inspection of the preforms and is designed to discharge defective preforms so that only defect-free preforms are output to the at least one container treatment machine. Alternatively, the first operation can, for example, also be a spacing with which the preforms are output by the production machine. The first operation can, for example, be regulated by means of a first operating parameter of the production machine, such as a cycle time or an injection time.

However, the first operation can also be an operation of the production machine that is not directly related to the preforms produced per time interval by the production machine. In this case, the first operating parameter can also be an operating parameter that can parameterize any component of the production machine and does not directly influence the preform throughput of the production machine. For example, the first operating parameter in this case may be a tool temperature of a production tool of the production machine. The first operating parameter can also indicate a state of wear of the production machine and/or a component of the production machine.

Furthermore, the first operating parameter can also be a material-specific parameter of a material processed by the production machine, such as a granulate or a melt, or a preform produced by the production machine. The material-specific parameter can be for example a preform temperature, an infrared characteristic value of the preform, an intrinsic viscosity value of the preform, a color of the preform, or any other material property of the preform produced by the production machine. The material-specific parameters can for example be measured by at least one sensor device, which can be assigned to the production machine or can be included in the production machine.

The first operation can for example be described by at least one first operating parameter. It can be provided that the first operation can comprise a plurality of first operating parameters of the production machine, some of which may be related to the number of preforms produced by the production machine per time interval and some of which may be unrelated to the number of preforms produced per time interval.

In particular, the second operation can be a throughput achievable by the container treatment machine of preforms or containers per time interval, for example per hour, or a number of containers that can be throughput or output by the container treatment machine per time interval. The second operation can be regulated, for example, by means of a second operating parameter of the container treatment machine.

However, the second operation can also be an operation of the at least one container treatment machine that is not directly related to the throughput of preforms or containers that can be achieved by the at least one container treatment machine. For example, the second operation can also be a parameterization of a treatment step carried out by the at least one container treatment machine on the preforms or containers which leads to a change in a material property of the preform or container, but does not necessarily have to influence the container throughput that can be achieved by the container treatment machine. If the container treatment machine is a blow molding machine, the second operating parameter can be a heating profile of the blow molding machine, for example.

Corresponding to the first operation, the second operation can also be described by at least one second operating parameter. It can be provided here, for example, that the second operation may comprise a plurality of second operating parameters of the at least one container treatment machine, some of which may be related to the number of preforms treated by the container treatment machine per time interval and some of which may be unrelated to the number of preforms treated per time interval.

Synchronization of the first and second operation can generally be understood to mean that the first operation and the second operation are coordinated with each other. For example, a first operating parameter of the production machine and a second operating parameter of the at least one container treatment machine can be coordinated with each other. This can be understood to mean, for example, that the first operating parameter is regulated based on the second operating parameter or the second operating parameter is regulated based on the first second operating parameter.

For example, synchronization of the first and second operation can be understood to mean that the first operation of the production machine and the second operation of the container treatment machine are coordinated with one another, so that the preforms produced by the production machine do not have to be temporarily stored, for example, and can be further processed directly by the at least one container treatment machine arranged downstream in the transport direction, in particular so that the throughput (also output rate) of the production machine and the container treatment machine are the same. Synchronization of the first and second operation can, for example, be carried out by the control unit when the production machine and/or the at least one container treatment machine is started. Alternatively, the first and second operation can also be synchronized during operation, for example at fixed time intervals.

Furthermore, synchronization can also be understood to mean, for example, that the second operation, such as a heating profile of a blow molding machine, is also regulated based on a material-specific parameter, such as a preform temperature or an infrared characteristic value, of a preform produced by the production machine.

The container treatment system according to the disclosure thus enables preforms to be produced and further processed into containers in one and the same system, wherein the synchronization of the first and second operation enables the container treatment system to be operated as efficiently as possible and the quality of the preforms produced to be improved. In particular, this can prevent damage to the preforms caused by storage and/or transportation, which can typically occur with externally produced preforms or during intermediate storage of the preforms, and can save storage and transportation costs. Furthermore, contamination of the preforms due to transportation or storage can be prevented. Consequently, by integrating the production machine and at least one container treatment machine and synchronizing the first and second operation, the quality of the containers produced from the preforms can be increased and the production or treatment process can be made more efficient.

In one embodiment, the first operation may comprise an output rate of the production machine, a first operating parameter of the production machine which may influence a property of a preform produced by the production machine, and/or a property of a preform produced by the production machine, and the second operation may comprise a throughput rate of the at least one container treatment machine and/or a second operating parameter of the at least one container treatment machine which may influence a property of a preform and/or container treated by the at least one container treatment machine. The output rate or throughput rate refers to the number of preforms/containers that can be output or processed per time interval, for example per hour, by the production machine or the at least one container treatment machine. The property of the preform produced by the production machine can be understood to mean, for example, a material-specific parameter of the preform, such as a preform temperature, an infrared characteristic value of a preform, an intrinsic viscosity of a preform, a color of a preform, or any other material property of the preform. The same applies to the property of the treated preform and/or container, which can also be a wall thickness distribution, for example. The output rate and throughput rate can be easily determined and flexibly regulated and can therefore be easily synchronized by the control unit.

In a further embodiment, the control unit can be designed to regulate the second operation of the at least one container treatment machine based on the first operation of the production machine. This can be provided in particular if the second operation of the at least one container treatment machine is easier to control or regulate compared to the first operation of the production machine or if the production machine is to serve as a master machine of the container treatment system.

In a further embodiment of the preceding embodiment, the control unit can be configured to determine the first operation based on a cycle time, a number of cavities of a production tool of the production machine, a preform temperature, an infrared characteristic of a preform, an intrinsic viscosity of a preform, and/or a color of a preform. The cycle time is understood as the time required to produce a preform with the production machine. A cavity, in turn, is a cavity of a production tool of the production machine into which the liquid material, for example liquid plastic, is injected to produce the preform, wherein the shape of the cavity determines the shape of the finished preform. The cycle time and the number of cavities are directly related to the output rate of the production machine and are therefore suitable parameters for determining the output rate.

In one embodiment, the production machine can comprise an inspection machine for detecting and rejecting defective preforms, and the control unit can be designed to adapt the first or second operation based on a number of rejected preforms. In this way, synchronous operation between the production machine and the container treatment machine can also be ensured if the first operation, or the output rate (as the number of preforms transferred to the subsequent container treatment machine per unit of time), of the production machine changes over time due to the rejection of defective preforms, even though the number of containers produced with the production machine per unit of time remains constant.

In one embodiment, the control unit can be designed to regulate the first operation of the production machine based on the second operation of the at least one container treatment machine. This can be provided if the first operation of the production machine can be controlled more easily than the second operation of the at least one container treatment machine or if the at least one container treatment machine is intended to serve as the master machine of the container treatment machine.

In a further development of this embodiment, the at least one container treatment machine can comprise a transport component and the control unit can be designed to determine the second operation based on a holding capacity of the transport component and/or a container throughput rate that can be achieved by the transport component. The holding capacity of the transport component and/or the container throughput capacity of the transport component are directly related to the second operation, or the throughput capacity, of the at least one container treatment machine and are therefore suitable variables for determining the second operation.

In a development of either of the preceding two embodiments, the regulating of the first operation of the production machine can comprise regulating at least one of a cycle time, a lock-to-lock time, an injection duration, a drying parameter, a production tool temperature, a number of post-cooling units associated with the production machine, and/or a post-cooling duration. The injection duration describes the time duration for which a material, for example liquid plastic, is injected into a cavity of the production tool, and the production tool temperature describes the temperature of the production tool before the material is injected into the cavity of the production tool. The post-cooling units can, for example, be designed as blowers and be intended to cool the preform to a specific target temperature, while the post-cooling duration describes the period of time for which the preform is cooled by the post-cooling units. Lock-to-lock time is the time required for the production tool to open and close. During this time, no preforms can be produced in the production machine, so that the lock-to-lock time can be equated to a dead time. A drying parameter can be understood as an operating parameter of the production machine that influences the drying process of the produced preform. Since the variables just described are directly related to the first operation of the production machine, they are suitable for regulating the first operation of the production machine.

In addition, according to the disclosure, a method for controlling an operation of a container treatment system is provided, wherein the container treatment system comprises a production machine for producing a preform, in particular an injection molding machine, at least one container treatment machine arranged downstream of the production machine in a transport direction of the preform, and a control unit, wherein the production machine and the at least one container treatment machine are integral with one another and wherein a first operation of the production machine and a second operation of the at least one container treatment machine are synchronized with one another by means of the control unit.

Using the method according to the disclosure, the preforms can thus be produced and further processed into containers in the same system. Synchronous operation of the production machine also means that intermediate storage of the preforms before they are fed to the at least one container treatment machine can be avoided. In particular, this can prevent storage and transportation costs as well as damage that can be caused either during storage, transportation, or intermediate storage in the container treatment system, and can increase the quality of the containers produced from the preforms. In addition, the method according to the disclosure can save energy, since the residual heat of the preforms after the production process can be used for the subsequent treatment steps, such as for a blow molding process.

In one embodiment, the first operation may comprise an output rate of the production machine, a first operating parameter of the production machine which may influence a property of a preform produced by the production machine, and/or a property of a preform produced by the production machine, and the second operation may comprise a throughput rate of the at least one container treatment machine and/or a second operating parameter of the at least one container treatment machine which may influence a property of a preform and/or container treated by the at least one container treatment machine. Since the output rate, the throughput rate, the first and second operating parameters, and the specified material-specific parameters can be determined and regulated relatively easily, these variables are particularly suitable for achieving coordination of the first and second operation of the production machine and the at least one container treatment machine.

In one embodiment, the second operation of the at least one container treatment machine is regulated based on the first operation of the production machine. This can be provided in particular if the first operation of the production machine is more difficult to adjust or is less flexibly adjustable than the second operation, or if the production machine is to serve as the master machine of the container treatment system.

In a development of this embodiment, the first operation is determined based on a cycle time, a number of cavities of a production tool of the production machine, a preform temperature, an infrared characteristic value of a preform, an intrinsic viscosity of a preform, and/or a color of a preform. As the first two variables are directly related to the output rate of the production machine, the output rate can be determined easily and precisely using these parameters. The material-specific parameters can in turn influence the treatment steps carried out on the preforms and/or containers by the at least one container treatment machine, and are therefore suitable for coordinating the first and second operation.

In one embodiment, the production machine comprises an inspection machine for detecting and rejecting defective preforms, and the first or second operation is adjusted based on a number of rejected preforms. This also ensures a synchronized first and second operation when rejecting faulty preforms and an associated temporally variable first operation or a temporally variable first output rate.

In one embodiment, the first operation of the production machine is regulated based on the second operation of the at least one container treatment machine. This can be particularly advantageous if the second operation of the container treatment machine is difficult to regulate or if the at least one container treatment machine is to serve as master machine. Thus, in this case as well synchronous operation between the production machine and the at least one container treatment machine can be ensured.

In a further embodiment of this embodiment, the at least one container treatment machine comprises a transport component and the second operation is determined based on a holding capacity of the transport component and/or a container throughput rate of the transport component, and/or the first operation is regulated based on a cycle time, a lock-to-lock time, an injection duration, a drying parameter, a production tool temperature, a number of post-cooling units assigned to the production machine, and/or a post-cooling duration. Since the aforementioned variables are directly related to the first or second operation, simple and precise determination or simple and precise regulation of the first or second operation can be achieved by determining or regulating these variables.

### BRIEF DESCRIPTION OF THE FIGURES

FIG. 1: A container treatment system comprising a production machine and at least one container treatment machine, according to one embodiment

### DETAILED DESCRIPTION OF THE FIGURES

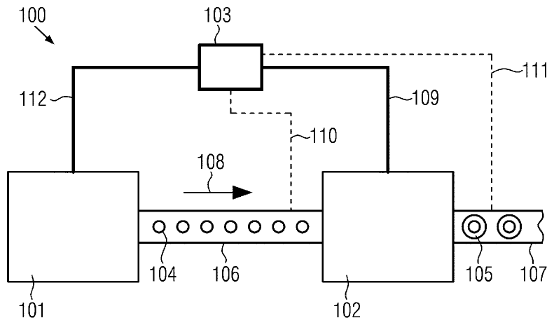

FIG. 1 shows a container treatment system 100 according to one embodiment, which according to the disclosure comprises a production machine 101 and at least one container treatment machine 102 arranged downstream of the production machine 101 in a transport direction 108 of the preforms, wherein the production machine 101 and the container treatment machine 102 are integral with one another and thus form a unit. According to the disclosure, the container treatment system 100 further comprises a control unit 103 which is designed to synchronize a first operation of the production machine 101 and a second operation of the at least one container treatment machine 102.

The production machine 101 can be designed to produce preforms 104. In particular, the production machine 101 can be set up to process plastics materials of any kind. Optionally, however, these are plastics materials which are suitable for producing a preform 104. For example, the production machine can be designed to process polyethylene terephthalate (PET) or to manufacture preforms 104 from PET. Alternatively, the production machine 101 can also be designed, for example, to process polyethylene (PE) or polypropylene (PP) and to produce preforms 104 made of PE or PP. However, these examples are not to be understood as limiting, so that any other suitable plastics material can also be processed by the production machine 101 to form a preform 104.

The production machine can be in particular an injection molding machine. Alternatively, it can also be a device for producing preforms by means of a compression molding method or a device for producing preforms by means of an injection compression molding method. However, it can also be any other device suitable for producing a preform. The production machine 101 can comprise a production tool. The production tool can in turn comprise a cavity or a hollow space, wherein the cavity or the hollow space can represent a negative impression of the preform 104 which is to be manufactured by means of the production machine 101. For example, the production tool can also comprise a plurality of cavities, such as two, five, or ten cavities. Thus, a plurality of preforms 104 can be produced simultaneously with the production tool in one process step, whereby the output rate of the production machine 101 can be increased. The production machine 101 may further comprise a plurality of post-cooling units to cool the preforms 104 produced by the production tool to a specified temperature.

Optionally, the production machine 101 can comprise a magazine for a plurality of different production tools, wherein the different production tools comprise differently shaped cavities or hollow spaces, so that preforms 104 of different types can be produced with the production machine 101 as required.

In one embodiment, the preforms can be provided in an ordered manner by the production machine.

In the embodiment discussed in connection with FIG. 1, the at least one container treatment machine 102 is configured as a blow molding machine 102. The blow molding machine can be, for example, a stretch blow molding machine or an extrusion blow molding machine. The sub-steps of the forming process (stretching, blowing) can be carried out independently of the geometrical location of the preforms.

The blow molding machine 102 can be designed to form the preform 104 provided by the production machine 101 into a container 105 of any type. In an embodiment, the container 105 is a bottle used in the beverage industry. However, this design of the container 105 produced by the blow molding machine is not to be understood as limiting. Alternatively, the blow molding machine 102 may, for example, also be designed to form the preform 104 into, for example, a can, a glass, a cup, or a tube, such as those used in the beverage, pharmaceutical, healthcare, or food industries, or into any other container which can be suitable for holding any liquid or pasty medium.

The embodiment just discussed of the at least one container treatment machine 102 as a blow molding machine 102 is to be understood as being by way of example. The at least one container treatment machine 102 can also be designed as any other type of container treatment machine designed to produce a container from a preform and/or to treat a container. For example, the container treatment machine can also be a machine for pretreating containers, for example with a flame pyrolysis, plasma or corona method, a filler, a labeling device, a direct printing device, and/or a capper. The possible embodiments just discussed of the at least one container treatment machine are to be understood as exemplary and not limiting.

In one embodiment, it can also be provided that more than one container treatment machine 102 is arranged downstream of the production machine 101 in the transport direction 108 of the preforms 104. For example, a blow molding machine can be arranged downstream of the production machine 101 in the transport direction 108, a filler can be arranged downstream of the blow molding machine in the transport direction 108, a capper can be arranged downstream of the filler in the transport direction 108, and a labeling machine can likewise be arranged downstream of the capper. However, any other combination or any other number of container treatment machines arranged downstream of the production machine is also conceivable.

According to the disclosure, it is provided that the production machine 101 and the at least one container treatment machine 102, or the blow molding machine 102 discussed in connection with FIG. 1, are integral with one another. In this context, integral means in particular that the production machine 101 and the at least one container treatment machine 102 form a unit and are connected to one another in such a way that the preforms 104 produced by the production machine 101 can be transferred to the at least one container treatment machine 102 for further processing. In FIG. 1, the preforms 104 produced in the production machine 101 are transferred to the blow molding machine 102, where they are formed into containers 105.

Optionally, a first transport device 106 can be provided between the production machine 101 and the blow molding machine for transferring the preforms to the blow molding machine 102.

Also optionally, a second transport device 107 can be provided downstream of the blow molding machine 102, by means of which the containers 105 formed by the blow molding machine 102 can be transported away from the blow molding machine 102 or transferred to a further container treatment machine (not shown in FIG. 1 1) arranged downstream of the blow molding machine in the transport direction 108. In an alternative embodiment, as already described in detail above, it can be provided that, for example, a further container treatment machine is provided downstream of the blow molding machine 102 for pretreating, filling, labeling, printing, and/or closing the containers 105.

In the embodiment described in connection with FIG. 1, the optional transport devices 106 and 107 are designed as linear transport devices. This type of design is to be understood as exemplary and not limiting.

Alternatively, it can also be provided that the optional first 106 and the optional second transport device 107 are designed as a rotating star. In this case, for example, the at least one container treatment machine 102, designed here as a blow molding machine 102, can also be designed as a rotary machine. In the case of the blow molding machine 102, when realized as a rotary machine, it can comprise a plurality of blow molds for receiving preforms, wherein the blow molds can be arranged along the circumference of the rotary machine. In this case, a blowing unit can be assigned to each of the blow molds, by means of which unit a preform can be formed into a container 105 in a blow mold by applying compressed air.

According to the disclosure, the control unit 103 is designed to synchronize the first operation of the production machine 101 and the second operation of the at least one container treatment machine 102 or the blow molding machine 102 discussed in connection with FIG. 1.

In particular, the first operation can involve a number of preforms 104 which can be produced per time interval, for example per hour, by means of the production machine 101, or a number of preforms 104 which can be output per time interval, for example per hour, to the container treatment machine 102 arranged downstream in the transport direction 108. The number of preforms 104 that can be produced by the production machine 101 per time interval and the number of preforms 104 that can be output by the production machine 101 per time interval can be different, for example if the production machine 101 performs an optional inspection of the preforms and is designed to discharge defective preforms so that only defect-free preforms are output to the at least one container treatment machine 102 or the blow molding machine 102. Alternatively, the first operation can also involve for example a spacing between two preforms with which the preforms are output by the production machine 101. The first operation can for example be regulated by means of a first operating parameter, such as a cycle time, an injection time, or a post-cooling time.

However, the first operation may also be an operation of the production machine 101 which is not directly related to the preforms produced per time interval by the production machine 101. In this case, the first operating parameter can also be an operating parameter that can parameterize any component of the production machine and does not necessarily have to influence the preform throughput of the production machine. In this case, the first operating parameter can be, for example, a tool temperature of a production tool of the production machine. The first operating parameter can also indicate a state of wear of the production machine and/or a component of the production machine.

Furthermore, the first operating parameter may also be a material-specific parameter of a material processed by the production machine 101, such as a granulate or a melt, or of a preform produced by the production machine 101. The material-specific parameter can be for example a preform temperature, an infrared characteristic value of the preform, an intrinsic viscosity value of the preform, a color of the preform, or any other material property of the preform produced by the production machine. The material-specific parameters can for example be measured by at least one optional sensor device. The optional sensor device can for example be designed as a separate device from the production machine or can be included in the production machine 101.

The first operation can for example be described by at least one first operating parameter.

It can further be provided that the first operation can comprise a plurality of first operating parameters of the production machine, some of which may be related to the number of preforms produced by the production machine per time interval and some of which may be unrelated to the number of preforms produced per time interval.

In particular, the second operation can be a throughput achievable by the container treatment machine 102 of preforms or containers per time interval, for example per hour, or a number of containers that can be processed by the container treatment machine 102 per time interval. The second operation can be regulated, for example, by means of a second operating parameter of the container treatment machine. In the case of a blow molding machine, the second operating parameter can for example be a preheating time of the preform 104 before the blowing process is carried out, or a blowing time.

However, the second operation can also be an operation of the at least one container treatment machine that is not directly related to the throughput of preforms or containers that can be achieved by the container treatment machine. For example, the second operation can also be a parameterization of a treatment step carried out by the container treatment machine on the preforms or containers which leads to a change in a material property of the preform or container, but does not necessarily have to influence the container throughput that can be achieved by the at least one container treatment machine. If the container treatment machine is a blow molding machine, the second operating parameter can be a heating profile of the blow molding machine, for example.

Corresponding to the first operation, the second operation can also be described by at least one second operating parameter.

It can further be provided for example that the second operation may comprise a plurality of second operating parameters of the container treatment machine, some of which may be related to the number of preforms and/or containers treated by the container treatment machine per time interval and some of which may be unrelated to the number of preforms and/or containers treated per time interval.

In one embodiment, the first operation may comprise an output rate of the production machine 101, a first operating parameter of the production machine which may influence a property of a preform produced by the production machine 101, and/or a property of a preform produced by the production machine 101, and the second operation may comprise a throughput rate of the at least one container treatment machine 102 and/or a second operating parameter of the at least one container treatment machine which may influence a property of a preform and/or container treated by the at least one container treatment machine. The output rates of the production machine 101 and the throughput rate of the at least one container treatment machine 102 are easily determinable and flexibly regulable and therefore particularly suitable for synchronizing the first and second operations of the production machine 101 and the at least one container treatment machine 102. Synchronizing the first and second operations can generally be understood to mean that the first operation and the second operation are coordinated with each other. For example, a first operating parameter of the production machine and a second operating parameter of the at least one container treatment machine can be coordinated with each other. This can be understood to mean, for example, that the first operating parameter is regulated based on the second operating parameter or the second operating parameter is regulated based on the first second operating parameter.

In a more specific embodiment, synchronizing the first and second operations can mean, for example, that the first operation of the production machine 101 and the second operation of the container treatment machine 102 are coordinated with one another, so that the preforms produced with the production machine 101 can be transferred in an ordered manner to the container treatment machine arranged downstream in the transport direction 108 of the preforms and can be further processed there directly without the need for intermediate storage of the preforms produced by the production machine in an intermediate buffer unit. Since the preforms are typically stored as bulk material in an intermediate buffer unit and must be separated again before being fed to the at least one container treatment machine 102, synchronizing the first and second operations not only allows the container treatment system 100 to be operated more efficiently, but also avoids potential damage to the preforms 104 due to intermediate storage. Optionally, such an intermediate buffer device can nonetheless still be provided.

Furthermore, it can also for example be provided that the second operation, such as a heating profile of a blow molding machine, is also regulated based on a material-specific parameter, such as a preform temperature or an infrared characteristic value, of a preform produced by the production machine. Furthermore, it can also be provided for example that a first operation of the production machine, which can influence a property of a preform produced by the production machine 101, such as a tool cooling of a tool of the production machine 101, is to be regulated based on a second operation of the at least one container treatment machine 102. In this case, the second operation can be, for example, a heating profile of the blow molding machine shown in FIG. 1, or any other second operating parameter.

The control unit 103 can be designed as a computer or computing system and can be designed to determine and regulate the first operation of the production machine 101 and the second operation of the at least one container treatment machine 102. For this purpose, the control unit 103 can, for example, be connected to the production machine 101 via a first cable connection 112 and to the at least one container treatment machine 102, or the blow molding machine 102, via a second cable connection 109, wherein the control unit 103 can send data to the production machine 101 and the at least one container treatment machine 102 and can also receive data from the machines. Alternatively, it may also be provided that the control unit 103 communicates wirelessly, for example via a WLAN connection, with the production machine 101 and the at least one container treatment machine 102.

The control unit 103 can also comprise a memory unit. A database can be stored on the memory unit, which can comprise a plurality of first operating parameters for controlling the first operation of the production machine 101 and a plurality of second operating parameters for controlling the second operation of the at least one container treatment machine 102. In particular, at least one first operating parameter value can be assigned in the database to a specific first operation of the production machine 101, and at least one second operating parameter value can be assigned to a specific second operation of the at least one container treatment machine 102. Consequently, based on the data stored in the database, the control unit 103 can retrieve the at least one first operating parameter value necessary to achieve a particular first operation of the production machine and, based thereon, adjust the at least one operating parameter of the production machine 101 to achieve a particular first operation of the production machine 101.

The same applies analogously to the at least one second operating parameter value and the second operation of the at least one container treatment machine 102. Furthermore, in the database, at least one first operation of the production machine 101 can be assigned a corresponding second operation of the at least one container treatment machine and vice versa, the assignment being selected such that the first and second operations are synchronized. Based on the information stored in the database, the control unit 103 can then regulate the other operation, for example based on a first or second operation, in such a way that the first and second operations are synchronized. For this purpose, the control unit 103 can, for example, regulate the at least one operating parameter of the other operation, and thus achieve synchronous operation. The regulation can include, for example, adjusting the first or second operating parameter based on the first or second operating parameter value obtained from the database.

In an alternative embodiment, for example, it can also be provided that the control unit 103 is connected to the Internet and can access an external server, wherein the server comprises a database on which the information just described is stored.

In one embodiment, the control unit 103 may be connected to the first 106 and/or the second transportation device 107 via cable or wireless connections 110, 111 and is designed to control the first 106 and/or the second transportation device 107. For example, the control unit 103 can be designed to control a transport speed of the first and/or the second transport device. If the first 106 and/or second transport device 107 is designed as a rotary star, it may also be provided that the control unit 103 is designed to control a rotational speed of the first and/or second transport device. In one embodiment, it may be provided that the control unit for synchronizing the first and second operation additionally controls the first and/or the second transport device, which can comprise for example controlling the transport speed and/or the rotational speed of the first and/or second transport device.

In a more specific embodiment, it can be provided that the control unit 103 is designed to regulate the second operation of the at least one container treatment machine 102 based on the first operation of the production machine 101.

This can be the case in particular if the production machine 101 is intended as the master machine of the container treatment system 100. Alternatively, this can also be the case for example if a maximum output rate that can be achieved by the production machine 101, i.e., the maximum number of preforms 104 that can be output by the production machine 101 per time interval, for example per hour, is smaller than a maximum number of preforms 104 that can be processed or output in an identical time interval by the at least one container treatment machine 102 arranged downstream in the transport direction 108, or the blow molding machine 102.

In order to regulate the second operation of the at least one container treatment machine 102, it can be provided in one embodiment that the control unit 103 first determines the first operation based on a first operating parameter of the production machine 101. If the first operating parameter is a material-specific parameter of the material for producing the preform or a material-specific parameter of the preforms produced, it can be determined by the optional sensor device described above.

The control unit 103 can determine the first operation based, for example, on a number of cavities of the production tool of the production machine or a cycle time of the production process. For this purpose, the control unit 103 can for example access the database stored in the memory unit, where a specific first operation is assigned to a specific cycle time value and/or a specific number of cavities of the production tool. The first operation determined in this way can, for example, be an output rate of the production machine, which can assume a value of for example 1,000 preforms per hour, 5,000 preforms per hour, or 20,000 preforms per hour. Based on the first operation determined in this way, the control unit 103 can then determine a setpoint value for a second operation based on the data stored in the database of the memory unit and can correspondingly regulate the second operation of the blow molding machine, or generally of the at least one container treatment machine 102, so that the first and second operations are synchronized. The same procedure can also be used for any other first operating parameter.

The regulation of the second operation can for example comprise regulating at least one second operating parameter of the blow molding machine 102 or of the at least one container treatment machine 102. For this purpose, the at least one second operating parameter can be set to the target value determined using the database. Alternatively, it is also possible for the regulation to be carried out by means of a control loop.

Furthermore, in one embodiment it can be provided that the production machine 101 comprises an inspection machine by means of which defective preforms can be detected and rejected. For this purpose, the inspection machine can comprise a first detection device, which can for example be designed as at least one camera. By means of the detection device, for example scratched, deformed, or otherwise damaged preforms can be detected and rejected directly in the production machine 101. It can thus be ensured that only defect-free preforms 104 are fed to the at least one container treatment machine 102 arranged downstream in the transport direction, or to the blow molding machine, and thus the quality of the containers treated by the at least one container treatment machine 102, or of the containers produced by the blow molding machine 102, can be increased.

Since in the embodiment just discussed the output rate of the production machine 101, which corresponds to the number of defect-free preforms output in a certain time interval, can be lower than the number of preforms produced by the production machine 101 at a certain operating parameter, which can be determined for example as described above on the basis of the at least one operating parameter and/or a property of the production machine, such as the number of cavities of the production tool, it can be provided in this embodiment that the number of defective or rejected preforms is taken into account when determining the first operation.

Thus, in one embodiment the production machine can produce a number of N preforms per unit of time. On average, a number of M defective preforms can be rejected by the production machine per unit of time (for example depending on an inspection result, as described above), so that the production machine can effectively output a number of N-M preforms per unit of time. N and M are natural numbers here. The control unit can then be designed to determine the first operation of the production machine 101 based on the number N-M of preforms output per time unit. Based on the first operation determined in this way, the control unit 103 can then regulate the second operation of the at least one container treatment machine 102 so that the first and second operations are synchronized with one another.

In one embodiment, for example, it may be provided that the production machine 101 is designed to produce a number (N) of 2000 preforms per hour and that an average number (M) of 30 defective preforms is rejected per time unit. This means that the production machine effectively outputs 1970 preforms per hour. Based on this number, i.e., the 1970 preforms that are actually output by the production machine 101 to the downstream container treatment machine 102, the operation of the downstream container treatment machine 102 is then regulated. This embodiment is not to be understood as limiting in particular with respect to the indicated number of produced and/or rejected preforms, so that any other number of preforms per time unit or any other number of preforms rejected and any other ratio of preforms rejected to preforms produced can also be used here. In an alternative embodiment, for example, it can also be provided that a number of 500, 1,000, or 5,000 preforms are produced per hour by the production machine, and 5, 10, or 40 defective preforms are rejected per hour. However, N and M can also assume any other value.

To determine the first operation, it can also be provided in one embodiment that a second detection device is arranged at an outlet of the production machine 101, through which the defect-free preforms are provided to the at least one container treatment machine 102 arranged downstream in the transport direction, which detection device can also be designed as at least one camera, and is designed to determine the number of preforms actually output in a specific time interval. Alternatively, for example, it may also be provided that the second detection device determines the spacing between two preforms 104 output by the production machine 101, and that the first operation of the production machine 101 is determined based on the spacing between two output preforms 104. If, for example, a defective preform is rejected by the inspection machine, the spacing between the preform produced before and after the defective preform will be twice as large as the spacing between two defect-free preforms produced directly one after the other. Based on this, the second operation can then be regulated so that the first operation of the production machine 101 and the second operation of the blow molding machine 102, or of the at least one container treatment machine, are also synchronized in this case.

In an alternative embodiment, it can be provided that the first operation of the production machine 101 is controlled based on the second operation of the at least one container treatment machine 102. This can be the case if the at least one container treatment machine 102 is provided as the master machine of the container treatment system 100. Alternatively, this can for example also be provided that if a maximum throughput that can be achieved by the at least one container treatment machine 102, i.e., the maximum number of preforms per time interval, for example per hour, that can be processed by the container treatment machine 102, is smaller than a maximum number of preforms that can be output in an identical time interval by the production machine 101 arranged upstream in the transport direction. However, this can also be provided if a material-specific parameter of the material for producing the preforms, a material-specific parameter of the produced preforms, or a first operating parameter of the production machine 101 which can have an influence on a property of a preform produced with the production machine 101, is to be adapted to the second operation of the at least one container treatment machine 102. For example, the quality of the containers produced can be improved by coordinating the first and second operation accordingly. In a more specific embodiment, it can be provided that the at least one container treatment machine 102 comprises a transport component and the control unit is designed to determine the second operation based on a holding capacity of the transport component and/or a container throughput achievable by the transport component. In one embodiment, for example, the transport component can be designed as a linear transport component, such as a conveyor belt. In an alternative embodiment, the transport component can be designed as a rotary star or a sawtooth star.

In the case of a linear transport component, for example, the holding capacity can be given by the width of the linear transport component, in the case of a rotary star by the number of gripper arms of the rotary star, and in the case of a sawtooth star by the number of pockets of the sawtooth star.

The container throughput of the linear transport component can also depend on the transport speed at which the linear transport component is operated. In the case of the rotary star or the sawtooth star, the container throughput can in turn depend on the rotational speed of the rotary star or the sawtooth star.

Based on the second operation of the at least one container treatment machine 102 or the blow molding machine 102 determined in this way, the control unit 103 can then be designed to regulate the first operation of the production machine 101 in such a way that the first and second operations are synchronized. As already described above in connection with the regulation of the second operation based on the first operation, the control unit 103 can access the database stored in the memory unit for this purpose. Based on this, the control unit 103 can then, for example, regulate at least one first operating parameter of the production machine 101 in order to synchronize the first and second operations.

In particular, the regulation can include the control unit setting the at least one first operating parameter to a set value determined using the database. The regulation can also for example be implemented using a control loop.

In one embodiment, the regulation of the first operation can comprise, for example, regulating at least one of a cycle time, a lock-to-lock time, an injection time, a drying parameter, a production tool temperature, a number of post-cooling units associated with the production machine, and/or a post-cooling time. Injection time refers to the period of time for which a material, for example liquid plastics material, is injected into a cavity of the production tool. A drying parameter can be understood as an operating parameter of the production machine that influences the drying process of the produced preform. The production tool temperature, in turn, is the temperature of the production tool before the material is introduced into the cavity of the production tool. The post-cooling units can be designed as blowers, for example, and are intended to cool the preform to a specific target temperature after it has been removed from the production tool. The post-cooling time, on the other hand, describes the period of time for which the preform is cooled by the post-cooling units. Lock-to-lock time is the time required for the production tool to open and close. During this time, no preforms can be produced in the production machine, so that the lock-to-lock time can be equated to a dead time. As these variables are directly related to the first operation and can be regulated simply and precisely, they are particularly suitable for regulating the first operation.

In one embodiment, it may be provided that in the event of a malfunction in a component of the container treatment system, such as a container treatment machine or a transport device, the control unit is designed to identify the malfunction and to adjust a speed of the components of the container treatment system that are arranged upstream of the component that has a malfunction. In the event of a malfunction, the output capacity of the components in particular can be adjusted and the container treatment system can continue to operate in a regulated manner. The malfunction could be, for example, a bottle bursting in the filler or foaming over of a liquid in the filler. However, it can also be any other malfunction in any other component of the container treatment system.

Depending on the newly set speed, the operating parameters of the components of the container treatment system can then be individually adjusted. For example, the operating parameter can be a heating capacity, a pre-blowing time, an injection parameter, a buffer capacity, a stretching speed, etc.

As already described above, the first operation of the production machine can also be a material-specific parameter of a preform produced by the production machine. In this case, for example, it may be provided to control the second operation based on the material-specific parameter of the preform. By controlling the second operation based on the material-specific parameter, the material-specific parameters can be taken into account in the downstream treatment and the quality of the preforms treated by the at least one container treatment machine can be improved in this way.

If the material-specific parameter is, for example, a preform temperature or an infrared characteristic value of the preform and the at least one container treatment machine 102, as described in connection with FIG. 1, is a blow molding machine, it can be provided that a heating profile or also any other machine parameter of the blow molding machine is controlled based on the preform temperature or the infrared characteristic value. A controlling can also be based on any other material-specific parameter of the preform.

Furthermore, it can also be provided that a first operation of the production machine 101, such as a tool cooling of the production machine 101, is controlled based on a second operation of the at least one container treatment machine, such as the blow molding machine. The second operation can be for example a speed control of the at least one container treatment machine 102 or any other second operating parameter of the at least one container treatment machine.

In general, it can be provided that any second operation of a container treatment machine 102 downstream of the production machine is synchronized with the first operation of the production machine. This can also include for example coordination of granulate drying in the production machine with the second operation of the downstream at least one container treatment machine, up to synchronization of a second operation of a labeling machine or packaging machine with the first operation of the production machine.

In one embodiment, it may be provided that the adapted operating parameters are determined by a neural network. The neural network may be a trained neural network. To determine the adjusted operating parameters, the neural network can, for example, access a data set that can be stored locally in the control unit or on an external server, such as a cloud.

Alternatively, the adjusted operating parameters can also be determined using a deterministic algorithm (such as a program with defined variables and functions). The deterministic algorithm can be stored locally on the control unit or externally on a server, such as a cloud.

1. A container treatment system comprising a production machine for producing a preform, at least one container treatment machine arranged downstream of the production machine in a transport direction of the preform, and a control unit, wherein the production machine and the at least one container treatment machine are integral with one another, wherein the control unit is designed to synchronize a first operation of the production machine and a second operation of the at least one container treatment machine with one another.

2. The container treatment system according to claim 1, wherein the first operation comprises an output rate of the production machine, a first operating parameter of the production machine, which can influence a property of a preform produced by the production machine and/or a property of a preform produced by the production machine, and the second operation comprises a throughput rate of the at least one container treatment machine and/or a second operating parameter of the at least one container treatment machine, which can influence a property of a preform and/or container treated by the at least one container treatment machine.

3. The container treatment system according to claim 1, wherein the control unit is designed to regulate the second operation of the at least one container treatment machine based on the first operation of the production machine.

4. The container treatment system according to claim 3, wherein the control unit is adapted to determine the first operation based on a cycle time, a number of cavities of a production tool of the production machine, a preform temperature, an infrared characteristic value of a preform, an intrinsic viscosity of a preform, and/or a color of a preform.

5. The container treatment system according to claim 1, wherein the production machine comprises an inspection machine for detecting and rejecting defective preforms, and the control unit is designed to adapt the first or the second operation based on a number of rejected preforms.

6. The container treatment system according to claim 1, wherein the control unit is designed to regulate the first operation of the production machine based on the second operation of the at least one container treatment machine.

7. The container treatment system according to claim 6, wherein the at least one container treatment machine comprises a transport component and the control unit is designed to determine the second operation based on a holding capacity of the transport component and/or a container throughput achievable by the transport component.

8. The container treatment system according to claim 6, wherein regulating the first operation of the production machine comprises regulating at least one of a cycle time, a lock-to-lock time, an injection duration, a drying parameter, a production tool temperature, a number of post-cooling units associated with the production machine, and/or a post-cooling duration.

9. A method for controlling an operation of a container treatment system, wherein the container treatment system comprises a production machine for producing a preform, at least one container treatment machine arranged downstream of the production machine in a transport direction of the preform, and a control unit, wherein the production machine and the at least one container treatment machine are integral with one another, wherein a first operation of the production machine and a second operation of the at least one container treatment machine are synchronized with one another by means of the control unit.

10. The method according to claim 9, wherein the first operation comprises an output rate of the production machine, a first operating parameter of the production machine which can influence a property of a preform produced by the production machine and/or a property of a preform produced by the production machine, and the second operation comprises a throughput rate of the at least one container treatment machine and/or a second operating parameter of the at least one container treatment machine which can influence a property of a preform and/or container treated by the at least one container treatment machine.

11. The method according to claim 9, wherein the second operation of the at least one container treatment machine is regulated based on the first operation of the production machine.

12. The method according to claim 11, wherein the first operation is determined based on a cycle time, a number of cavities of a production tool of the production machine, a preform temperature, an infrared characteristic of a preform, an intrinsic viscosity of a preform, and/or a color of a preform.

13. The method according to claim 9, wherein the production machine comprises an inspection machine for detecting and rejecting defective preforms, and the first or the second operation is adapted based on a number of rejected preforms.

14. The method according to claim 9, wherein the first operation of the production machine is regulated based on the second operation of the at least one container treatment machine.

15. The method according to claim 14, wherein the at least one container treatment machine comprises a transport component and the second operation is determined based on a holding capacity of the transport component and/or a container throughput achievable by the transport component and/or the first operation is regulated based on a cycle time, a lock-to-lock time, an injection duration, a drying parameter, a production tool temperature, a number of post-cooling units associated with the production machine, and/or a post-cooling duration.

16. The container treatment system according to claim 1 wherein the production machine is an injection molding machine.

17. The method according to claim 9, wherein the production machine is an injection molding machine.
